(19) United States
(12) Patent Application Publication
(10) Pub. No.: US 2005/0282002 A1
(43) Pub. Date: Dec. 22, 2005

(54) Electrically anisotropically conductive hotmelt adhesive for implanting electrical modules in a card body

(75) Inventors: Marc Husemann, Hamburg (DE); Maren Klose, Seevetal (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 10/998,702

(22) Filed: Nov. 29, 2004

(30) Foreign Application Priority Data
Jun. 18, 2004 (DE) 10 2004 029 589.1

(51) Int. Cl. B32B 5/16

(52) U.S. Cl. 428/328; 428/333

(57) ABSTRACT

Adhesive sheet, especially for adhesively bonding electrical modules in card bodies, composed at least of a layer of an adhesive system based on at least one heat-activable adhesive, characterized in that the softening temperature of the adhesive system is situated in the range from 65° C. to 165° C., electrically conductive particles are admixed with the adhesive system, the particles having on average a diameter of from 25 to 100 μm, with the proviso that the average diameter of the conductive particles is greater than the layer thickness of the adhesive system, the conductive particles have a copper or nickel core.

The invention relates to an anisotropically electrically conductive hotmelt adhesive for bonding electrical modules in card bodies and also for permanently establishing electrical contact between electrical module and antenna in the card body.

In relation to the implanting of electrical modules in card bodies the prior art has already disclosed a multiplicity of adhesive sheets or joining methods. The aim of such implantations is to produce telephone cards, credit cards, parking machine cards, insurance cards, etc. Examples of the corresponding adhesive bonding methods can be found for example in patents EP 0 842 995, EP 1 078 965 and DE 199 48 560.

In this field of adhesive bonding, the bar is continually being raised as regards the requirements imposed on the adhesive system. For instance, the adhesive must adhere well to polycarbonate, to ABS, PVC and PET, and also to the electrical module. Bonding here is generally to epoxy materials, polyesters or polyimides. At one time cyanoacrylates were used as liquid adhesives, and had the advantage of optimum wetting of both the card body and the electrical chip. This technology, however, is dying out, since the processes are very slow. The evaporation of the solvent from the cavity in the card body was slow; the metering nozzles became blocked during down time, as a result of drying out, and were also of poor meterability; and the liquid adhesive likewise required a certain time for curing. As a result, the quality of the adhesive bond was decidedly poor.

Pressure-sensitive hotmelt adhesives prove to be markedly superior to the liquid adhesives. Nevertheless, here as well, the selection of suitable compounds is very limited, since extremely exacting requirements are imposed on this joining technique.

For the production of the cards known as dual interface smart cards there is a further problem, since here the adhesive is additionally required to take on the function of anisotropic electrical conductivity. Anisotropically conductive adhesives of this kind have already been known for a long time. At their most simple, a defined quantity of electrically conductive particles is admixed with the adhesive. The choice of concentration makes it possible to prevent the development of conductivity in the XY direction. Electrical conductivity in the Z direction is achieved by making some of the electrically conductive particles larger in diameter than the layer thickness of the adhesive. After pressing, therefore, direct contact is produced between the electrical contacts to be connected.

The patent literature has already described a multiplicity of anisotropically conductive adhesives. U.S. Pat. No. 4,606,962 describes adhesive transfer tapes comprising electrically conductive and thermally conductive particles. The particles are compressed when pressure and temperature are exerted. In order to achieve this the particles are equipped with two layers. On temperature activation either the core or the outer shell of the electrically conductive particle melts. Examples of readily melting compounds of this kind include lead alloys. Systems of this kind, however, are unsuitable for use in the smart card field, since to bring about bond strength the adhesive matrix as well is melted and it is therefore possible for instances of phase separation to occur, which in adverse cases prevent adhesive bonding between the pad of the antenna and the chip module. Moreover, through the melting of the electrically conductive layer, there is risk of a short circuit, since in the region of the melting the electrically conductive area is increased significantly.

U.S. Pat. No. 5,499,730 describes a process for producing anisotropically electrically conductive adhesive tapes. In that case the corresponding particles are placed on the adhesive at regular intervals, since otherwise there is a risk of the particles being destroyed in the course of the extrusion processing operation.

U.S. Pat. No. 5,685,939 describes a process for aligning electrically conductive particles in the Z direction. Alignment takes place by way of electromagnetic radiation. This process is only rational for elongate or acicular particles.

U.S. Pat. No. 6,042,894 describes the use of electrically conductive particles.

U.S. Pat. No. 6,452,111 uses special electrically conductive particles having a diameter of between 10 and 90 nm. These particles are not suitable for use in dual interface smart cards, since the layer thicknesses of the bond are too low. It would no longer be possible to compensate surface roughnesses from the milling of the card and the electrical modules by means of the adhesive.

U.S. Pat. No. 6,451,875 describes the use of electrically conductive particles having an elastic core. The elasticity is produced, for example, by a polymer. The anisotropically conductive adhesives are used for bonding semiconductors. For use in dual interface smart cards, however, these adhesives are not suitable. The cards are required to withstand flexural stress. This exerts a continuous force on the particles, so that in the course of long-term stressing the electrically conductive layer would break up.

U.S. Pat. No. 6,426,021 proposes an anisotropically conductive adhesive based on a reactive system and electrically conductive particles for bonding IC chips. Reactive systems, however, have the drawback that, owing to reactions, substances may be released that promote the corrosion of the electrically conductive particles or else, as a gaseous component, build up an opposing pressure and therefore act counter to the bond.

Another important criterion for application are temperature fluctuations and the effect of moisture, since in the course of their subsequent use these cards are required to withstand both high and low temperatures and even in some cases to survive laundering. Accordingly the adhesive should not become brittle at low temperatures, should not become liquid at high temperatures, and should possess a low propensity to absorb water.

In light of this state of the art the object on which the invention is based is to specify an anisotropically electrically conductive adhesive sheet for implanting electrical modules into a card body, which meets the criteria specified above.

In accordance with the invention this object is achieved by means of an anisotropically conductive adhesive sheet composed at least of a layer of an adhesive system based on at least one heat-activable adhesive, the softening temperature of the adhesive system being situated in the range from 65° C. to 165° C., where electrically conductive particles have been admixed with the adhesive system, the particles further having on average a diameter of from 25 to 100 μm, with the proviso that the average diameter of the conductive particles is greater than the layer thickness of the adhesive system. The indications of the softening temperature are made with reference to the measurement method according to DIN 53460.

Particularly advantageous in accordance with the invention is an adhesive sheet for which the added conductive particles have a copper or nickel core, and/or for which the conductive particles have a gold or silver sheath.

A particularly advantageous adhesive sheet is one composed of a thermoplastic and optionally one or more resins, where
a) the adhesive system has a softening temperature of greater than 65° C. and less than 165° C.
b) electrically conductive particles having a copper or nickel core and a silver metal sheath are admixed homogeneously with the adhesive system, in a fraction of from 2% to 60% by weight relative to the adhesive
c) the particles have on average a diameter of from 25 to 100 μm, the average diameter being at least 5 μm greater than the layer thickness of the adhesive.

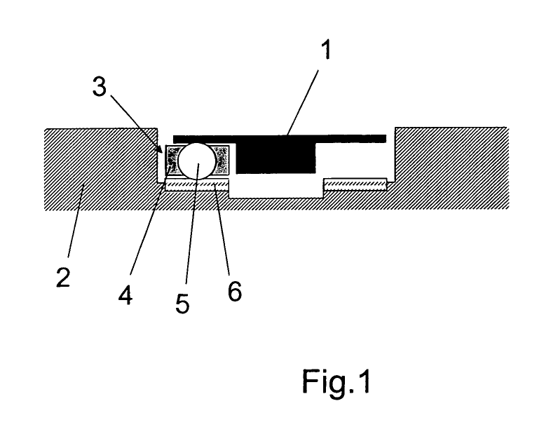

The bonding of the electrical module to a card body is depicted diagrammatically in FIG. 1). In that figure, 1 identifies the dual interface module, 2 the card body, 3 the adhesive sheet of the invention, composed of the adhesive 4 and the admixed electrically conductive particles 5, and 6 the antenna. In one preferred embodiment the inventive temperature-activable adhesive has a layer thickness of between 20 and 95 μm, in a particularly preferred embodiment a layer thickness of from 30 to 80 μm.

Heat-Activable Adhesive

For the purpose of bonding the electrical module the heat-activable adhesive possesses high adhesion to epoxy materials, polyesters and polyimides, and for the purpose of bonding to card bodies it possesses good adhesion to PC, ABS, PVC and PET. One very preferred procedure uses thermoplastic materials, such as polyurethanes, polyesters, polyamides, ethylene-vinyl acetates, synthetic rubbers, such as styrene-isoprene diblock and triblock copolymers (SIS), styrene-butadiene diblock and triblock copolymers (SBS), styrene-ethylene-butadiene diblock and triblock copolymer (SEBS), polyvinyl acetate, polyimides, polyethers, copolyamides, copolyesters, polyolefins, such as polyethylene, polypropylene, or poly(meth)acrylates, for example. This recitation makes no claim to completeness.

The polymers possess a softening range of between 65 and 175° C.

In order to optimize the technical adhesive properties and the range of activation it is possible with advantage to add resins which enhance bond strength. The preferred proportion of the resins is between 2% and 50% by weight, based on the thermoplastic.

Additive tackifying resins which can be used are the tackifier resins described in the literature. Representatives that may be mentioned include pinene resins, indene resins and rosins, their disproportionated, hydrogenated, polymerized and/or esterified derivatives and salts, aliphatic and aromatic hydrocarbon resins, terpene resins and terpene-phenolic resins, and C5, C9 and other hydrocarbon resins. Any desired combinations of these and further resins can be used in order to adjust the properties of the resulting adhesive in accordance with what is required. Generally speaking, any resins which are compatible with (soluble in) the corresponding thermoplastic can be used; reference may be made in particular to all aliphatic, aromatic, alkylaromatic hydrocarbon resins, hydrocarbon resins based on single monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

In a further preferred embodiment epoxy resins are added. The molecular weight of the epoxy resins varies from 100 g/mol up to a maximum of 10 000 g/mol for polymeric epoxy resins.

The epoxy resins, comprise, for example, the reaction product of bisphenol A and epichlorohydrin, the reaction product of phenol and formaldehyde (novolak resins) and epichlorohydrin, glycidyl esters, and the reaction product of epichlorohydrin and p-aminophenol.

Preferred commercial examples are Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical and HPT™ 1071, HPT™ 1079, likewise from Shell Chemical.

Examples of commercial aliphatic epoxy resins are vinylcyclohexane dioxides, such as ERL-4206, ERL-4221, ERL 4201, ERL-4289 or ERL-0400 from Union Carbide Corp.

Examples of novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As resins it is additionally possible to use melamine resins, such as Cymel™ 327 and 323 from Cytec.

Further resins which can be used are terpene-phenolic resins, such as NIREZ™ 2019 from Arizona Chemical.

Phenolic resins as well can be among the resins used, such as YP 50 from Toto Kasei, PKHC from Union Carbide Corp. and BKR 2620 from Showa Union Gosei Corp.

Polyisocyanate resins can additionally be used, such as Coronate™ L from Nippon Polyurethan Ind., Desmodur™ N3300 or Mondur™ 489 from Bayer.

Besides resins it is also possible to employ plasticizers. Here, in one preferred embodiment of the invention, plasticizers can be used based on polyglycol ethers, polyethylene oxides, phosphate esters, aliphatic carboxylic esters and/or benzoic esters. In addition it is also possible to use aromatic carboxylic esters, higher molecular mass diols, sulphonamides and adipic esters.

A further possibility, optionally, is to add fillers (e.g. fibres, carbon black, zinc oxide, titanium dioxide, chalk, solid or hollow glass spheres, microspheres of other materials, silica, silicates), nucleators, expandants, compounding agents and/or ageing inhibitors, in the form for example of primary and secondary antioxidants or in the form of light stabilizers.

In another embodiment the adhesives used are polyolefins, especially poly-α-olefins, which have a softening range of greater than 65° C. and less than 175° C. and which likewise solidify again after adhesive bonding, in the course of cooling. Different heat-activable poly-α-olefins are available commercially from Degussa under the Vestoplast™ trade name.

In a preferred embodiment the polyolefin-activable adhesives have static softening temperatures T_{E,A} or melting points T_{S,A} of from +65° C. to 150° C. The bond strength of these polymers can be increased by adding specific additives. For instance, polyimine or polyvinyl acetate copolymers can be used as additives to promote bond strength.

In one very preferred version of the invention copolyamides are employed as thermoplastic adhesive. They are available commercially, for example, from Atofina.

Electrically Conductive Particles

As electrically conductive particles it is advantageous to use particles having a copper core or a nickel core. The sheath is composed very preferably of silver or of gold. The fraction of the sheath as a proportion of the total weight of the particle is preferably between 2% and 50%, more preferably between 5% and 25%, by weight. In one preferred version the particles have a spherical structure. In another very preferred version of the invention the particles have only a rough spherical structure, which possesses a fairly jagged surface, in order to enhance the anchorage of the particles on the antenna or on the dual interface module. The morphology of the spheres is then referred to more as granular.

Particles of this kind are available commercially from Nanotechnology BV under the trade name Sil-Shield Ag/Ni and Ag/Cu.

Production Process

For further processing for the adhesive bonding of electrical modules to card bodies, the adhesive tape must be made available on a release paper or a release liner.

Coating can take place from solution or, very preferably, from the melt. For application from the melt the solvent—if the polymer is in solution—is preferably stripped off in a concentrating extruder under reduced pressure, something which can be accomplished using, for example, single-screw or twin-screw extruders, which preferably distil off the solvent in different or identical vacuum stages and possess a feed preheater. Coating then takes place via a melt die or an extrusion die, with the film of adhesive being drawn if desired, in order to achieve the optimum coating thickness. Blending of the resins can be carried out using a compounder or a twin-screw extruder. For mixing with the electrically conductive particles, in one very preferred version, the thermoplastic polymer is converted into very small particles by grinding. In a second step a homogeneous mixture of thermoplastic adhesive and electrically conductive particles is then produced by combining the components in, for example, a Stephan stirrer. Subsequently the adhesive is melted in a single-screw extruder and then coated through an extrusion die with coathanger manifold.

Backing materials used for the adhesive are the customary materials familiar to the skilled person, such as films (polyester, PET, PE, PP, BOPP, PVC, polyimide), nonwovens, foams, woven fabrics and woven films, and also release paper (glassine, HDPE, LDPE). The backing materials ought to have been provided with a release layer. In one very preferred version of the invention the release layer is composed of a silicone release varnish or of a fluorinated release varnish.

The invention further provides for the use of an adhesive sheet as described above for bonding substrates to produce an electrically conductive contact of the substrates over the bond site, particularly for adhesively bonding electrical modules in card bodies. Preferably the particles are compressed in the adhesive bonding step, with exertion of pressure, especially under elevated temperature—that is, a temperature above ambient temperature—and the electrical contact area is increased as a result, relative to the condition of the bond without compression. In a very preferred way the temperature in the adhesive bonding step is between 120° C. and 250° C.

It proves to be very advantageous, as a result of bonding with the adhesive sheet of the invention, if the particles, after bonding, mesh with the electrical contacts, with exertion of stress (e.g., by flexing or other strong mechanical stresses) in order thus to maintain the electrical contact, particularly in the case of an adhesive bond as specified in the paragraph above.

### EXAMPLES

### Example 1

Platamid 2395 (copolyamide) from Atofina was dried in the form of 100 μm powder in vacuo at 40° C. for 24 h. Subsequently 40% by weight of silverized copper beads (diameter 50 μm, 24% by weight silver) was stirred in and the powder was homogenized in a drum on a drum roller for 24 h.

### Example 2

Platamid 2395 (copolyamide) from Atofina was dried in the form of 100 μm powder in vacuo at 40° C. for 24 h. Subsequently 40% by weight of silverized nickel beads (diameter 50 μm, 24% by weight silver) was stirred in and the powder was homogenized in a drum on a drum roller for 24 h.

Coating

Examples 1 and 2 were melted in an SIG single-screw extruder and coated through a Breyer die at 180° C. The adhesive film is laid off on a glassine release paper with graduated siliconization on either side. The coating weight of the adhesive after coating was about 60 g/m², the electrically conductive particles withstanding the extrusion process intact and protruding from the adhesive on the backing with an average diameter of 50 μm.

Implantation of the Electrical Modules

The electrical modules were implanted in the card body using an implanter from Ruhlamat.

The materials employed were as follows:
electrical modules: Philips Mifare
PVC cards with etched multitape antenna.

In a first step the samples from Examples 1 and 2 were laminated onto the module belt with a laminating pressure of 3 bar using the Mühlbauer CML 3400 machine.

The electrical modules were then implanted into the matching cavity in the card body.

The parameters employed for all examples were as follows:
Heating steps: 1
Punch temperature: 205° C.
Time: 1×1.5 s
Cooling step: 1×800 ms, 25° C.
Pressure: 200 N per module
   Test Methods:

Iso bending A)

The Iso bending test is carried out in analogy to the Iso/IEC standard 10373: 1993 (E)—section 6.1.

The test is passed if a total of more than 4000 bends are attained. Electrical contacting is checked by measuring the resistance of the module after each 250 bends. The test is only passed when there is no fall in the electrical conductivity.

Iso bending B)

The Iso bending test was carried out as for A), but after the samples have been stored for 15 days, in an alternating climate test. The climate was alternated between −30° C. and 65° C., with the atmospheric humidity being 0% at −30° C. and +95% at +65° C. The climate was alternated between the two temperatures and humidities every 6 h.

Results:

The chip cards produced with the inventive adhesives were tested according to test methods A and B. The results are set out in Table 1.

TABLE 1

| Examples | Test method A | Test method B |
|---|---|---|
| 1 | >4000 | >4000 |
| 2 | >4000 | >4000 |

Table 1 reveals that the inventive examples met the major criteria for a dual interface chip card and are therefore highly suitable for the adhesive bonding of electrical modules to card bodies. After the cards had undergone the test methods, the anisotropic conductivity was retained and the adhesives likewise showed no weaknesses after passing through the alternating climate test.

1. An adhesive sheet for adhesively bonding electrical modules in card bodies, having a layer of an adhesive system comprising at least one heat-activable adhesive, wherein
the softening temperature of said adhesive system is in the range of from 65° C. to 165° C.,
electrically conductive particles are mixed with the adhesive system, the particles having on average a diameter of from 25 to 100 μm, with the proviso that the average diameter of the conductive particles is greater than the thickness of said layer of adhesive system,
the conductive particles have a copper or nickel core.

2. Adhesive sheet according to claim 1, wherein the conductive particles have a gold or silver sheath.

3. Adhesive sheet according to claim 1, wherein the average diameter of the conductive particles is at least 5 μm greater than the thickness of the layer of adhesive system.

4. Adhesive sheet according to claim 1, wherein the proportion of the electrically conductive particles in the adhesive system is from 2% to 60% by weight, based on the weight of the adhesive system without said particles.

5. Adhesive sheet according to claim 1, wherein said electrically conductive particles are distributed homogeneously in the adhesive system.

6. Adhesive sheet according to claim 1, wherein the thickness of the layer of the adhesive system is in the range of 20 to 95 μm.

7. Adhesive sheet according to claim 1, wherein said heat-activable adhesives are thermoplastics.

8. A method for bonding substrates to produce electrically conductive contact of the substrates with each other over the site of the bond, which comprises bonding said substrates to each other with the adhesive sheet of claim 1, and during the process of bonding said substrates to each other, compressing the particles that are in the adhesive system of said adhesive sheet, with exertion of pressure, thereby increasing the electrical contact area, relative to the electrical contact area obtained without compression, at a temperature above ambient temperature.

9. The adhesive sheet according to claim 6, wherein said layer thickness is from 30 to 80 μm.
